(19) United States
(12) Patent Application Publication
(10) Pub. No.: US 2015/0236511 A1
(43) Pub. Date: Aug. 20, 2015

(54) METHOD FOR LIMITING THE LOADING OF ELECTRICAL POWER TRANSMISSION NETWORKS

(71) Applicant: EVONIK INDUSTRIES AG, Essen (DE)

(72) Inventors: Jörg Strese, Elversberg (DE); Gerd Hinüber, Alsdorf (DE); Christoph Butterweck, Hurth (DE); Georg Markowz, Alzenau (DE); Jürgen Erwin Lang, Karlsruhe (DE); Rüdiger Schütte, Alzenau-Horstein (DE)

(21) Appl. No.: 14/420,513

(22) PCT Filed: Aug. 8, 2013
(86) PCT No.: PCT/EP2013/066600

§ 371 Date: Feb. 9, 2015

(30) Foreign Application Priority Data
Aug. 9, 2012 (DE) 10 2012 107 348.1

(51) Int. Cl. H02J 3/38; H02J 3/14

(52) U.S. Cl. CPC H02J 3/382; H02J 3/14

(57) ABSTRACT

The present invention relates to a method for limiting the load of electricity transmission networks, comprising the generation of heat by operating an apparatus for the oxidation of a hydrocarbon-containing gas, in which alternatively a required provision of heat from the oxidation of the hydrocarbon-containing gas is substituted by the provision of heat from electrical energy with an apparatus for providing heat by using electrical power and the hydrocarbon-containing gas that is not oxidized is provided. A facility for carrying out the present method is also described.

The present invention relates to a method for limiting the load of electricity transmission networks.

The use of renewable energy sources, such as wind power, solar energy and hydropower, is gaining ever-increasing significance for the generation of electricity. Electrical energy is typically supplied to a multitude of consumers over long-ranging, supra-regional and transnationally coupled electricity supply networks, referred to as electricity networks for short.

A disadvantage of the use of renewable energy sources is the load of the electricity transmission networks. While conventional power generating plants can be built and operated without any problem in the vicinity of locations where electricity is required, plants for obtaining energy from sustainable forms can only be expediently installed at sites where the wind blows or the sun shines.

The site-bound nature of wind- and sun-based energy sources requires the construction of new electricity transmission networks or the expansion of existing networks. However, this expansion is expensive and requires extensive approval procedures. When the load limit is reached, it has in the past been necessary to reduce the amounts of power fed in, so that energy is lost.

In view of the prior art, it is thus an object of the present invention to provide an improved method for limiting the load of electricity transmission networks that is not affected by the disadvantages of conventional methods.

In particular, it was an object of the present invention to find ways of making it possible to reduce the expenditure on apparatus and operation with regard to the storage, transport and use of electrical energy as compared with the prior art.

Furthermore, it should be possible for the method to be scalable, so that relatively small facilities, which may also be of a modular construction, can be used for carrying out a method for the use and/or for the chemical storage of relatively small surpluses of electrical energy. Furthermore, decentralized operation of the facilities required for carrying out the method should be possible.

The method should also have the highest possible efficiency. Furthermore, the method according to the invention should allow itself to be carried out using infrastructure that is conventional and still available.

In addition, the method should allow itself to be carried out with the fewest possible method steps, but they should be simple and reproducible.

Furthermore, implementation of the method should not involve any risk to the environment or human health, so that it should be possible to largely dispense with the use of toxic substances or compounds that could involve disadvantages for the environment.

Further objects that are not explicitly mentioned arise from the overall context of the following description and the claims.

These and further objects that are not expressly mentioned but can be readily deduced or inferred from the circumstances discussed at the beginning are achieved by a method with all of the features of patent claim 1. Expedient modifications of the method according to the invention for limiting the load of electricity transmission networks are afforded protection in the dependent claims 2 to 24.

The subject matter of the present invention is accordingly a method for limiting the load of electricity transmission networks, which is characterized in that the method comprises the generation of heat by operating an apparatus for the oxidation of a hydrocarbon-containing gas, wherein alternatively a required provision of heat from the oxidation of the hydrocarbon-containing gas is substituted by the provision of heat from electrical energy with an apparatus for providing heat by using electrical power and the hydrocarbon-containing gas that is not oxidized is provided.

This succeeds in an unforeseeable way in providing a method of the aforementioned generic type that has a particularly good set of properties, while the disadvantages of conventional methods can be largely avoided.

In particular, it has been found in a surprising way that it is thereby made possible to be able to use electrical energy that has been generated for example from renewable energy sources, including wind power or photovoltaics, without having to build new electricity transmission networks or expand existing networks. In this case, electricity can be transformed, in particular at a particularly high load, into a storable form with the present method. Here it is possible to resort to a simultaneously existing infrastructure, the load limit of which often has not been reached. In this context, reference is made in particular to the efforts being made to save energy by introducing insulation regulations for residential buildings and similar measures in other technical areas that lead to a reduction in the load of existing natural gas networks.

The method allows a hydrocarbon-containing gas, preferably natural gas, to be provided without expensive large-scale facilities having to be constructed and maintained for this. On account of the small number of steps and the high efficiency with which electrical energy can be converted into thermal energy and used efficiently, the overall efficiency of the present method is very high. Relatively lower investment costs are necessary here.

The present method be operated very dynamically so that a hydrocarbon-containing gas can be provided in a very short time without losses of efficiency. Furthermore, the method of the present invention can be carried out in a decentralized manner. This allows the method also to be carried out during servicing work on part of the plants that are used for providing a hydrocarbon-containing gas.

In addition, it is possible to convert existing facilities in a relatively simple way, so that, with a small investment expenditure, great savings in natural gas are possible by expedient use of “surplus” electricity.

Furthermore, the present method allows the real option value to be increased, since it allows gas and electricity to be exchangeable, so that both control energy for the gas network and control energy for the electricity network can be provided.

In addition, the method can be carried out with relatively few method steps, but they are simple and reproducible.

Furthermore, implementation of the method does not involve any risk to the environment or to human health, such that is possible to dispense largely with the use of toxic substances or compounds that could involve disadvantages for the environment.

The method of the present invention serves in particular for limiting the load of electricity transmission networks. Electricity transmission networks are in the present case connections for the transmission of electrical power and/or energy. These networks are not subject here to any particular limitations, and so DC and/or AC electricity networks are covered by the present invention.

The load of the electricity transmission network relates here in particular to the load of the lines that make up the electricity transmission network. The load of the lines connecting locations of high electricity generation to locations of high electricity demand should be taken into consideration here. Generally, there may be multiple lines between these locations, possibly using multiple node points. What is important is that the load of all the possible transmission paths is at such a level that electrical energy or electrical power can take place only at the expense of temporary overload of the transmission lines. In this respect it should be stated that the transmission lines are authorized for a specific current and voltage, the admissible current and voltage values being determined by the type of line, in particular the diameter and/or the insulation of the transmission line. If load is too high, i.e. there is a current intensity that is too high, the temperature of the line increases, so that damage to the line may be feared. Accordingly, these lines are produced for particular specifications that are known to the network operator, for example the distribution network operator and/or the transmission network operator.

Accordingly, load can be determined in a customary way, it being possible for example to use the temperature of the transmission line and/or the present current intensity. The current intensity may be measured here for example by way of induction. The transmission network operator may allow short-term instances of overload.

Preferably, prior to using the electrical energy for providing thermal energy, the load of the power transmission network may at least be at least 70%, with preference at least 80%, with particular preference at least 90% and with special preference at least 95% with respect to the maximum continuous load capability of the electricity network. The maximum continuous load capability of the electricity network represents here the load capability in terms of the current intensity and voltage of the respective transmission line that is maintained over a time period of at least 20 h without causing any measurable, permanent damage to the transmission line. This maximum continuous load capability is generally known to the network operator and may be dependent on weather conditions. At a high ambient temperature, the transmission line can generally transmit a lower current intensity.

The electricity transmission network of which the load is to be limited may preferably be connected to subnets or be made up of subnets. Generally, electricity transmission networks, in particular networks that operate with high voltages and transmit energy over great distances, comprise a number of voltage levels.

Here, high voltages are suitable for transmitting high levels of power with a relatively small loss, but require very rigorous safety precautions. For this reason, electricity is often transported over multiple voltage levels from the power plants to the small consumers, which in Europe are supplied with 380 V or 220 V. Major industrial customers and public utilities may be supplied with higher voltages. Generally, at least 3 voltage levels are used, supra-regional long-distance transmission networks generally being operated at voltages of at least 200 kV, regional distribution networks generally being operated in the range from 50 to 200 kV, preferably 60 to 150 kV and with particular preference approximately 110 kV, medium-voltage networks being operated in the range from 1 kV to 50 kV, preferably 5 to 40 kV, and low-voltage networks being operated below 1 kV, preferably in the range from 230 V to 690 V. The individual voltage levels of an electricity transmission network are usually connected by transformers, possibly power transformers, which are operated in substations. In Europe, the interconnected networks operated regionally by transmission network operators are grouped together to form a large network (UCTE interconnected network), in order to increase the security of the network. The grouping together of various regional networks, with four transmission network operators being active in Germany at present, takes place by switching systems. The substations and switching systems contained in an electricity network represent node points of the electricity transmission network.

Accordingly, the electricity transmission network of which the load is to be limited is preferably connected to subnets or is made up of subnets. Here, the term subnet means that the electricity transmission network is made up of subregions, which may be at the same voltage level. This can be realized, for example, on each voltage level by the aforementioned switching systems. Furthermore, an electricity transmission network may have a number of voltage levels, so that the electricity transmission network may for example have a high or highest voltage level which is connected by transformers to one or more subnets that are operated at a medium voltage or a low voltage.

Furthermore, it may be provided that the electrical energy that is alternatively used for providing heat is consumed and is provided by plants, preferably plants for generating electricity from renewable energy sources, within a subnet. This dispenses with transmission of the electricity via a power line into another subregion of the electricity transmission network of which the load is to be limited. These subregions are defined here by the aforementioned switching systems and/or transformers.

The subnet may comprise here multiple component networks or be connected to them. For example, the aforementioned regional distribution network may supply multiple medium-voltage networks, so that the regional distribution network can be regarded as a subnet and the medium-voltage networks can be regarded as a component network.

The electricity transmission network may be operated preferably with a voltage of at least 10 kV, with preference at least 30 kV, with particular preference at least 80 kV and with special preference at least 200 kV. In the case of an electricity transmission network which is connected to subnets that are operated at a lower voltage, these figures relate to the voltage of the network level with the highest voltage of which the load is to be limited.

The method comprises the generation of heat by operating an apparatus for the oxidation of a hydrocarbon-containing gas. A hydrocarbon-containing gas is understood according to the invention as meaning a gas that comprises high proportions of hydrocarbons. These gaseous hydrocarbons include, in particular, methane, ethane, propane, ethene, propene and butene. Apart from gaseous hydrocarbons, the gas may also comprise other gaseous compounds. The hydrocarbon-containing gases particularly include naturally occurring and/or synthetically produced natural gas. Generally, the hydrocarbon-containing gas that is used may have a proportion of methane, ethane, propane, ethene, propene and butene, preferably a proportion of methane that is at least 50% by volume, with preference at least 60% by volume and with particular preference at least 80% by volume.

The present method comprises the generation of heat by operating an apparatus for the oxidation of a hydrocarbon-containing gas. The apparatus for the oxidation of a hydrocarbon-containing gas is not subject to any specific restrictions, thus covering gas burners, gas motors and gas turbines. Gas burners with low or high output may be used here, such as for example monobloc burners, which generally have an output of up to 10 MW, or larger burners, which often comprise a separate blower. Furthermore, the gas burner may have a separate ignition burner. Accordingly, the gas burner may be used in simple gas heaters or in devices for generating steam by burning gas.

Preferably, the apparatus for the oxidation of a hydrocarbon-containing gas may comprise a combined heat and power generating plant. Furthermore, the method of the present invention may be used in a unit-type cogenerating plant. The combined heat and power generating plant or the unit-type cogenerating plant may comprise here a gas motor and/or a gas turbine.

The use of a combined heat and power generating plant for carrying out the present method allows surprising advantages to be achieved, in particular with regard to the energy required for the provision of heat. Based on the gas that is used for generating heat and electricity, the use of electricity instead of gas can achieve efficiencies of over 100%, these high efficiencies being achieved in particular because even in a combined heat and power generating plant waste heat that cannot be expediently used is produced. Furthermore, based on the gas that is obtained or can be provided in a combined heat and power generating plant, relatively low outputs are necessary for heat generation. Since a combined heat and power generating plant generates not only heat but also electricity, considerable gas can be provided even with a relatively low installed capacity of the apparatus for providing heat by using electrical power. Here it should be taken into consideration that providing electricity from a combined heat and power generating plant is not expedient when there is a great supply of electricity from renewable energy sources, since surplus electricity cannot be easily stored. In the case of a combined heat and power generating plant which, on the basis of the energy content of the gas that is used, generates about 40% electricity, 40% useful heat and 20% waste heat, the installation of a heating capacity of the apparatus for providing heat by using electrical power of 40% is sufficient to substitute the useful heat output that is provided by the combined heat and power generating plant. On the other hand, however, the output of 100% of the gas required for this is conserved, and can be provided.

Preferably, therefore, the ratio of the installed heating capacity of the apparatus for providing heat by using electrical power to the total capacity of the combined heat and power generating plant may lie in the range from 1:1 to 1:10, with preference 1:1.5 to 1:5 and with particular preference 1:1.8 to 1:4. The total capacity of the combined heat and power generating plant is calculated here from the consumption of gas, and consequently represents the potential for providing gas by the use of electricity from renewable energy.

Surprisingly, the present invention in combination with the use of combined heat and power generating plants also offers the advantage of being able to reliably make electricity available even in a network with a high proportion of energy from renewable sources. Energy from renewable sources cannot be provided on a planned basis. However, the necessary storage facilities are relatively expensive, so that, when there is a low supply of energy from renewable sources, in particular solar or wind power, conventional plants are used. With the use of combined heat and power generating plants, a very considerable amount of gas is conserved at times when there is a high supply of energy from renewable sources, since the plant can be shut down, while the heat requirement can be covered by the use of electricity. This gas can, however, be used for electricity generation at times of a low supply of energy from renewable sources, so that it is possible to counteract in an economical way the planning uncertainty that is involved in the use of renewable energy sources.

Apart from the aforementioned provision of heat from the oxidation of the hydrocarbon-containing gas, the present invention also comprises an apparatus for providing heat by using electrical power.

The apparatus for providing heat by using electrical power is not subject to any specific limitations. Accordingly, the apparatus for providing heat by using electrical power may for example transform electrical energy into heat by resistance heating and/or induction heating. Furthermore, electrical energy may be converted into thermal energy by microwaves, so that the apparatus for providing heat by using electrical power may generate microwaves.

Preferably, a thermoelectric heating system can take power from the network in large amounts, i.e. between 0.5 MW and 1 GW, with preference 1 to 500 MW. A single component can achieve this thermal output here. According to a preferred embodiment, these outputs may, however, be provided by a common group (“pool”) of multiple units, some of which are spatially separate, these separate units preferably being controlled by a central control device.

Furthermore, the taking of power from the electricity transmission network or the provision of electrical energy by an energy plant, for example a wind power or solar power plant, can be varied over time and in the power output, so that a very short-term reaction to changes in the supply of electricity or in the load of the network are possible. It should be stated here that the heat to be provided in a specific period of time can possibly be provided by the oxidation of gas. This allows the security of supply for the end users or major customers to be safeguarded.

Apparatuses and devices that have low wear and require little servicing are preferably used for carrying out the present invention. Furthermore, the by the apparatuses for generating heat are preferably designed such that they are not subjected to overload.

The type of apparatus for generating heat by the oxidation of hydrocarbon-containing gas or by the use of electrical energy is not critical. What is important is that the heat that is obtained by the electricity can replace or substitute the heat that is obtained by the oxidation of gas.

The degree of substitution, that is to say the proportion of thermal energy that can be substituted by the use of electrical energy, is not critical here. Thus, the ratio of the heating capacity achievable by gas to the heating capacity that is provided by electrical energy may lie in the range from 100:1 to 1:100, preferably in the range from 10:1 to 1:10, with particular preference in the range from 5:1 to 1:5 and with special preference in the range from 2:1 to 1:2.

With a very similar heating capacity of both apparatuses for generating heat, a very high degree of substitution can be achieved, so that surprising economic advantages can be achieved.

The possibility of generating necessary thermal energy alternatively by electrical energy or by the oxidation of a hydrocarbon-containing gas means that there is joint control over the apparatus for providing heat by using electrical power and the apparatus for the oxidation of a hydrocarbon-containing gas, so that a required amount of heat can be obtained alternatively by electrical energy or by oxidation of gas.

The term control should be understood here in a comprehensive sense, so that simple manually controlled switching over and/or switching on of the at least two units for generating thermal energy is encompassed. According to a preferred embodiment, one or more control devices, which with particular preference can be operated by way of a common control panel, may be used for performing the control. The control by these devices may be realized here semi-automatically or fully automatically. Preferably, the control may be assisted here by the use of a computer system. Return signals may be taken into consideration here in the control, so that the control can also be interpreted as meaning feedback control.

According to a preferred embodiment, the at least two apparatuses for generating heat, to be specific the apparatus for the oxidation of a hydrocarbon-containing gas and the apparatus for providing heat by using electrical power, are preferably designed such that they have good switchability. Furthermore, these apparatuses are distinguished by good reproducibility of the control.

The control of all the units may preferably be performed here jointly, in particular centrally, so that the internals for controlling the units, in particular the apparatus for the oxidation of a hydrocarbon-containing gas and the apparatus for providing heat by using electrical power, have devices which make communication possible. Known interfaces and data transmission devices may be used for this purpose, such as a LAN (Local Area Network), the Internet or other digital or analog networks.

The control of the at least two apparatuses for generating heat, to be specific at least one apparatus for the oxidation of a hydrocarbon-containing gas and at least one apparatus for providing heat by using electrical energy, also synonymously referred to here as electrical power, may take place in dependence on many different factors. These include, inter alia, the supply of electrical energy, the supply of gas and the load of the electricity transmission network.

Gas is usually supplied and traded in long-term contracts, so that the supply of gas can often be regarded as constant. However, in exceptional cases, for example when there is a technical defect, or in exceptional situations, for example of a political nature or when there is an enormously high consumption by the generating countries themselves, the gas supply may turn out to be low in an unplanned way. Accordingly, the method of the present invention leads to an improvement in the security of supply in exceptional situations.

It may preferably be provided that the method comprises the following steps:
a) determining the load of the electricity transmission network,
b) use of the electrical energy for generating heat if the load of the electricity transmission network exceeds a predetermined value,
c) use of gas for generating heat if the load of the electricity transmission network is below the aforementioned predetermined value.

The load of the electricity transmission network relates here in particular to the load of the lines that make up the electricity transmission network as already defined above.

The aforementioned predetermined value that serves for deciding on the type of heat generation may depend here on the requirements of the network operator and the access possibilities to the electricity network. Accordingly, the predetermined value may lie within a wide range. Preferably, this value may be at least 70%, with preference at least 80%, with particular preference at least 90% and with special preference at least 95% of the maximum continuous load capability of the electricity network. The maximum continuous load capability of the electricity network represents here the load capability in terms of the current intensity and voltage of the respective transmission line that is maintained over a time period of at least 20 h without causing any measurable, permanent damage to the transmission line. This maximum continuous load capability is generally known to the network operator and may be dependent on weather conditions. At a high ambient temperature, the transmission line can generally transmit a lower current intensity.

As already explained, the present method serves for limiting the load of electricity transmission networks. This method may also be used in particular for keeping the load relatively low, electricity being used for generating heat when a great amount of electricity is offered, when there is of a high level of supply in a subnet or part-network, as defined above.

According to a particular embodiment of the present invention, the use of electricity is preferably chosen in dependence on the supply of electrical energy. Here it should be stated that, when there is a high proportion of renewable energy sources for obtaining electricity, strong fluctuations in the electricity supply can be expected, since, as explained in more detail in the introduction, solar and wind energy cannot be provided on a planned basis over a relatively long timescale.

A preferred embodiment of the method of the present invention comprises the following steps:
a) determining the supply of electrical energy,
b) use of the electrical energy for generating heat if the supply exceeds a predetermined value,
c) use of gas for generating heat if the supply is below the aforementioned predetermined value.

The supply of electrical energy may be established for example by way of the frequency of the AC network, an oversupply existing when there is a frequency that is too high, so that heat is generated with electricity. When there is a frequency that is too low, gas is used with preference for heat generation. In Europe, the AC network operates at approximately 50.00 Hz, in the United States at 60.00 Hz. To maintain these frequencies, supplies of control power or control energy are provided in dependence on a frequency deviation, the responsibility for this being borne by the network operator, which in turn obtains control power or control energy from companies. A detailed description of this can be found, inter alia, in the Netztechnik/Netzbetrieb [network technology/network operation] forum of the VDE (FNN) “Transmission Code 2007” of November 2009.

Furthermore, the supply of electricity can be determined by way of trading platforms and/or by OTC methods and an associated electricity price. In the case of a low electricity price on account of a high supply, electrical energy can accordingly be used for heat generation. The price of gas necessary to generate a comparable amount of heat may be used here as a threshold. The trading platforms that can be used include in particular electricity exchanges, such as for example the European Energy Exchange (EEX). OTC (over-the-counter) methods refer to trading methods that are enacted outside of exchanges.

If the price for obtaining a specific amount of thermal energy from gas is lower than the price for electrical energy, gas is generally used for heat generation. If the price for obtaining a specific amount of thermal energy from electrical energy is lower than from gas, electricity is used for heat generation. If the price is identical, heat can be obtained with gas, with electricity or a mixture of the two possibilities. In the price determination, it is necessary of course to take into consideration related costs, such as for example costs for the storage of gas, servicing costs for the apparatuses, etc.

Preferably, an amount of thermal energy to be provided within a specific time period or at a specific time may alternatively be provided by burning gas and/or by using electrical energy. Accordingly, the electrical energy is preferably not merely converted into heat when there is a high load of the electricity transmission network or a high supply, but when there is an actual demand that exists during a predetermined time period and/or at a specific time. This allows the storage capacity of the heat reservoir to be minimized, while in particularly preferred cases no additional reservoir has to be used as a result of implementing the present method.

For example, it may be provided that the specific time period within which an amount of thermal energy is to be provided is at most 24 hours, preferably at most 12 hours, with particular preference at most 6 hours and with special preference at most 1 hour. These time periods may also recur, possibly one after the other for a sustained time. What is important, however, is that heat is only provided when there is an actual demand, the time component of the demand being taken into consideration.

The load of the electricity network or the supply of electrical energy may preferably be determined just before the provision of thermal energy. It may preferably be provided that the decision with regard to the type of provision of the thermal energy is taken at most 12 hours, preferably at most 6 hours, with particular preference at most 2 hours and with special preference at most 1 hour before the time period and/or the point in time over which or at which the thermal energy is to be provided.

Customary market enquiries can be used for determining the supply of electrical energy, so that the decision on whether a predetermined amount of thermal energy is provided by way of electrical energy or the burning of hydrocarbon-containing gas is dependent on an actual supply price.

Surprising advantages can be achieved, however, by predictions of the load of the electricity network or the supply of electricity being produced. In connection with the aforementioned renewable energy sources, data of weather forecasts may be used in particular. Furthermore, historical data on the demand or consumption of electrical energy may be used, in order to predict a possible surplus of electrical energy that can be used for the provision of thermal energy. Here, too, a prediction of the load of the electricity transmission network can be prepared, since this load can be predicted on the basis of the aforementioned data and the network capacity.

The data on historical consumption may comprise for example the daily variation, the weekly variation, the annual variation and further variations in terms of the electricity demand. The data on the consumption forecast may also take into consideration specific changes, for example the accession or discontinuation of a major consumer.

The data on the weather forecast may be produced over a time period of any desired length, but the reliability of the forecast data decreases over longer time periods. Therefore, the forecasts mentioned are usually produced for a time period of 30 minutes to 2 months, preferably 1 hour to 1 month, with particular preference 2 hours to 14 days and with special preference 24 hours to 7 days.

The preparation of the forecast may take place at any time before the time period to which the forecast applies, but the reliability is reduced if it is produced at a very early time. If the forecast is produced very late, however, the options for influencing a change are reduced. According to a preferred embodiment, therefore, many forecasts are carried out at relatively short intervals, where the respective results should be understood as instructions for future action, so that almost continuous adaptation can be achieved. Thus, when there is a deviation from an earlier forecast in the actual consumption values or the power output that is provided by the renewable energy, an adaptation of the energy source used for the generation of the necessary thermal energy is performed. This allows the achievement of a very short-term adaptation of the source that is expediently used for the generation of an required amount of thermal energy, without having to do without the advantages of an early offer to take electrical energy being issued that by the use of forecast data, in particular weather forecasts and/or consumption forecasts.

The present invention surprisingly allows a hydrocarbon-containing gas to be provided, this gas being obtained by avoided oxidation. The term “providing” means within the scope of the invention that the gas that is not oxidized can be used for other purposes. These other purposes include, inter alia, storage of the gas that is not oxidized, delivery of the gas that is not oxidized to other customers and use of the gas that is not oxidized as a raw material, for example in the chemical industry for the production of hydrogen cyanide (HCN), carbon disulphide (CS₂) and methyl halides.

The present method may serve, inter alia for obtaining a hydrocarbon-containing gas. Within the scope of the present invention, the term “obtaining” means in particular that control over, possession of and/or ownership of this gas is/are gained. Ownership of a gas is not gained by a gas simply not being drawn from a gas line. Rather, a hydrocarbon-containing gas is obtained if physical and/or legal control over gas that is conserved when it is not consumed is achieved, for example possession or ownership. This may be the case for example if a hydrocarbon-containing gas is provided by a supplier under long-term delivery contracts and the gas has to be taken. Furthermore, however, the term obtaining also comprises a conserved gas over which the operator of the method according to the invention has control or which was previously in the possession and/or ownership of that operator.

Surprisingly, the present invention succeeds in increasing the real option value. Real option value is understood within the scope of the present invention as meaning the possibility of using a specific power output or energy technically in a wide variety of ways. These diverse possibilities for use allow an improvement to be achieved in the cost-effectiveness of the apparatuses and facilities that are used.

Thus, it may be envisaged, inter alia, to use the method for balancing out or mitigating fluctuations that occur due to renewable energy sources, in particular due to the use of wind power plants. For example, a customer may be offered the feeding in of a specific, constant power into the electricity network, while higher power, occurring when there are strong winds, is used for the generation of thermal energy by the use of electricity as a result of the use of the present method. This allows the plannability of the network load to be improved.

Furthermore, the method may be used to provide control power or control energy to the operators of electricity transmission networks. As already explained above, the frequency of an AC network depends on the balance between power fed in and power drawn. When there is a surplus of power fed in, the frequency increases, when too much power is drawn, the frequency falls. To stabilize the network frequency to a predetermined desired frequency, accordingly balancing power outputs are required if unforeseeable events occur. These include for example power plant outages, interruptions in the electricity transmission network or a discontinuation of major consumers on account of unexpected defects. This desired frequency is currently 50.00 Hz in Europe and 60.00 Hz in the US, while these figures do not restrict the present invention.

To balance out insufficient feeding of energy into the network, i.e. a falling frequency, positive control energy is required, where this can be provided by increasing the feeding in, for example by increasing the power output of an electricity power plant, or by reducing the amount taken by certain consumers, generally major customers.

Negative control energy, which is required when there is a frequency that is too high, can be provided by reducing the feeding in, for example by reducing the power output of an electricity power plant, or by increasing the amount taken by certain consumers, generally major customers.

At present, three different types of control power are defined in Europe by the valid regulations, which are defined more specifically in particular by the UCTE (Union for the Co-ordination of Transmission of Electricity) or the organization succeeding it, the ENTSO-E (European Network of Transmission System Operators for Electricity).

In the currently applicable code of practice (UCTE Handbook), the respective requirements and types of control power are also specified. The types of control power have for example different requirements with regard to the time response to a frequency deviation. Furthermore, the types of control power defined so far differ in the time for which power is delivered. Furthermore, various boundary conditions apply with regard to the use of control power.

Surprisingly, a contribution to network stabilization can be made by the present invention even when there are unexpected fluctuations, and this lowers the environmental impact, in particular reduces carbon dioxide emissions. The control power for the electricity network that is obtained in this way is made possible by the provision or storage of electrical energy in the form of hydrocarbon-containing gas, which without the present method would have led to a release of carbon dioxide. Here, the provision of negative control power is preferred, since this does not necessitate sustained use of electrical energy. Thus, negative control power can be offered and delivered without being combined with a major consumer of electrical energy. Positive control power can likewise be provided. However, this requires sustained use of electrical energy for the generation of heat, or a consumer of electrical energy that is controllable, in particular can be cut back. Consumers that can be cut back particularly include in this context industrial plants that can be cut back in output, such as for example electrolysis plants or aluminium plants.

The provision of energy is also necessary in the gas network, in order to balance out differences between forecast demand and actual demand for gas. Generally, control energy in the gas network is understood as meaning the energy that is necessary for physically balancing out a gas network, the balancing being the responsibility of the gas network operator. Disequilibria to be balanced out are generally referred to as balancing energy.

The present method can accordingly be used to make control energy available to a gas network operator. When there is a surplus, i.e. a very high pressure in the network, according to the present invention gas can be used for providing thermal energy, while, when there is a shortfall of gas in the gas network, electrical energy is used for obtaining heat.

A particularly preferred embodiment of the method of the present invention is distinguished by the fact that the hydrocarbon-containing gas provided is stored. The use of a gas reservoir allows the aforementioned physical options to be combined, so that the method can be used for providing control energy for the electricity transmission network and at the same time for providing control energy for the gas network. Simultaneously occurring contributions of energy, i.e. feeding of gas into the gas network and of electrical power into the electricity network, can be secured here, where in this case gas from the gas reservoir is used to meet the obligation. Furthermore, gas obtained when there is a take-up of electrical energy in the case of the provision of negative control power for the electricity network can also be secured when there is a surplus supply of gas, i.e. a low gas price or a normal demand for negative control energy, in the gas network.

The use of a gas reservoir accordingly allows the achievement of temporal decoupling between the time at which the gas is obtained and the time at which the gas is used, leading to an unexpected increase in the possibilities that have been discussed above.

The hydrocarbon-containing gas provided may be stored in an overground reservoir and/or underground reservoir. With regard to underground reservoirs, cavern storage facilities and pore storage facilities may be mentioned, inter alia. Pore storage facilities are very inexpensive to maintain, but have disadvantages in terms of how gas is fed in and retrieved. Furthermore, in the case of an underground reservoir it is not possible for the entire gas that is fed in to be retrieved under cost-effective conditions, with pore storage facilities generally having disadvantages in comparison with cavern storage facilities in this respect, the gas concerned being known as cushion gas and often reflected in the costs of a gas reservoir. Porous storage facilities are often set up in depleted natural gas and/or oil fields. Furthermore, layers of rock that contain water and the water of which can be displaced by gas (aquifers) are suitable for the provision of porous storage facilities. Cavern storage facilities are set up in layers of rock (rock caverns) and rock salt formations (salt caverns).

Overground reservoirs are often provided with technical measures that reduce the volume requirement. For example, the gas may be stored as liquefied gas at low temperatures or at high pressure.

Among the most well-known overground reservoirs are spherical gas tanks, which operate under high pressure. With a diameter of the steel sphere of 40 m, a design for 10 bar is expedient, while pressures of up to 20 bar can also be realized if there is a correspondingly thick wall.

Pipe storage facilities are set up underground at a shallow depth, a hydrocarbon-containing gas, in particular natural gas, at a pressure of up to 100 bar being stored in pipes, which are preferably arranged in parallel.

Overground reservoirs, which on account of the shallow depth also include pipe storage facilities, are distinguished by a very high feed-in and retrieval rate. Accordingly, these reservoirs are suitable in particular for the provision of control energy for the gas network.

According to a particularly preferred embodiment, a combination of the aforementioned reservoirs, in particular a combination that comprises at least one overground reservoir and at least one underground reservoir, may be used, so that the advantages of overground reservoirs and underground reservoirs can be combined.

The spatial separation of all the apparatuses and component parts of a facility for carrying out the method according to the invention is not subject to any particular limitations. However, as already explained, the heat provided by the unit for generating thermal energy from electrical energy must be capable of substituting the thermal energy that is obtained by oxidation of gas. Accordingly, this requires a spatial proximity, but it is quite possible for the units to be several kilometers apart in industrial plants.

Furthermore, it may be provided that the hydrocarbon-containing gas provided is stored in spatial proximity to the apparatus for the oxidation of a hydrocarbon-containing gas. This embodiment of the method according to the invention surprisingly ensures minimal load of the gas network, so that on the one hand no entry-exit fees or other charges for using the gas network due to the lower consumption have to be paid. On the other hand, physical control over the gas obtained can also be ensured. This allows the provision of control gas, i.e. control energy, for the gas network to be ensured independently of other control devices.

Preferably, it may be provided that the gas inlet to the reservoir is at most 20 000 m, with particular preference at most 10 000 m and with particular preference at most 5000 m away from the gas inlet of the apparatus for the oxidation of a hydrocarbon-containing gas. For a combination of multiple apparatuses for the oxidation of a hydrocarbon-containing gas (pool of apparatuses for the oxidation of a hydrocarbon-containing gas), the distance of the apparatus for the oxidation of a hydrocarbon-containing gas that is at the smallest distance from the reservoir applies here, the figures referring to the distance in a straight line.

Furthermore, it may be provided according to another embodiment that the hydrocarbon-containing gas provided occurs with a spatial separation from the apparatus for the oxidation of a hydrocarbon-containing gas. This also allows storage devices that are bound to geographical requirements, such as the aforementioned porous and/or cavern storage facilities, to be used for carrying out the present method. Preferably, it may accordingly be provided that the gas inlet to the reservoir is at least 10 000 m, with particular preference at least 20 000 m and with special preference at least 50 km away from the gas inlet of the apparatus for the oxidation of a hydrocarbon-containing gas. For a combination of multiple apparatuses for the oxidation of a hydrocarbon-containing gas (pool of apparatuses for the oxidation of a hydrocarbon-containing gas), the distance of the apparatus for the oxidation of a hydrocarbon-containing gas that is at the smallest distance from the reservoir applies here, the figures being based on distances in a straight line.

According to a further embodiment of the present invention, at least one reservoir may be present nearby and at least one may be spatially separate. According to this embodiment, there may be at least one reservoir where the gas inlet to the reservoir is at most 19 000 m, with particular preference at most 10 000 m and with most particular preference at most 5000 m away from the gas inlet of the apparatus for the oxidation of a hydrocarbon-containing gas, and at least one reservoir where the gas inlet to the reservoir is at least 20 000 m and with special preference at least 50 km away from the gas inlet of the apparatus for the oxidation of a hydrocarbon-containing gas. In such a combination, the shortest distance applies to the reservoir nearby and the greatest distance applies to the reservoir that is spatially separate, the figures being based on distances in a straight line.

According to a further embodiment, the hydrocarbon-containing gas provided may be stored in the natural gas pipeline network by raising the pressure.

Preferably, the hydrocarbon-containing gas provided can be fed into a natural gas network that is connected to a gas power plant. The transferred gas may be used in the gas power plant for generating electricity. Here, the electricity transmission network of which the load is to be limited is preferably connected to subnets or is made up of subnets, the electrical energy that is alternatively used for providing heat not generating heat in the subnet into which the gas power plant feeds electricity. Here, the previous definition applies for the description of the subnets.

This embodiment allows electrical energy to be provided in a subnet or part-network without overload of the long-distance electricity transmission networks occurring. Thus, gas is provided in one subregion of the electricity transmission network by the use of electricity and is converted into electricity in another subregion. In this way, the gas network is used for purposes of electricity transmission. The various subregions referred to are defined here, as already explained above, on the basis of the power line of which the load is to be limited.

The source of the electrical energy that is used for carrying out the present method is not critical. Accordingly, the electrical energy may be generated by nuclear power plants, coal power plants, gas power plants, wind power plants and/or solar power plants.

According to a preferred embodiment, the electrical energy that is alternatively used for providing heat may originate at least partially from renewable energy sources, for example from wind power and/or solar energy.

However, it should be noted that, according to current legislation, electricity that has been obtained from renewable energy sources may be fed into the electricity network even without any specific demand and must be paid for. Accordingly, conventionally generated electricity may at times constitute a “surplus” and lead to a pronounced load of the electricity transmission network, since it may be less profitable for a power plant operator to throttle a power plant than to sell electricity below the cost price. This electrical energy obtained from the continued operation of conventional plants can surprisingly be used for providing hydrocarbon-containing gas.

The thermal energy provided by an apparatus for providing heat by using electrical power or an apparatus for the oxidation of a hydrocarbon-containing gas can be used variously. Preferably, it can be used for increasing the temperature of a liquid. Furthermore, it may be provided that the heat generated from electrical energy and/or by oxidation of gas increases the temperature of a liquid by at least 10° C., preferably at least 30° C., with particular preference at least 60° C. The temperatures are based here on the difference between the inlet temperature of the liquid entering the apparatus and the outlet temperature of the liquid.

According to a preferred embodiment, the thermal energy may serve for generating steam. Here, the apparatus for the oxidation of a hydrocarbon-containing gas may comprise in particular a device that can provide gas. Surprising advantages can be achieved if the apparatus for providing heat by using electrical power likewise generates steam. By surprisingly simple and low-cost modifications, it is possible in this way to upgrade existing plants, for example in industry, in particular the chemical industry, for carrying out the present method, without extensive internals and controls having to be installed in the various sections of the plants.

The present method can be used in all areas in which heat is generated by oxidation of gas. These include heating systems in single-family or multi-family dwellings, communal supply installations that for example provide district heating, and large-scale industrial plants, in particular chemical plants.

Surprising advantages can be achieved in particular in the case of methods that are used in conjunction with the generation of chemical products. In many plants, steam is centrally generated oxidation of gas and subsequently used for heating pipelines, boilers or evaporators. When electrical energy is used for the provision of heat, the present method can be modified in a manner that the necessary heat is fed directly to the devices or components to be heated, such as for example pipelines, boilers or evaporators. This may take place by the use of microwaves, by induction and/or by resistance heating. This surprisingly allows energy to be conserved, since the use of steam lines causes heat losses. This advantage is possible as a result of the very precise temperature setting and the easily controllable heat distribution of the devices or components heated by electricity.

Furthermore, the present method may be carried out in particular in combination with a combined heat and power generating plant, preferably a unit-type cogenerating plant, as explained above. Relatively small electricity generators that are operated with gas may be used here in particular, providing electricity and heat for single-family dwellings, residential buildings, relatively small businesses and hotels on a distributed basis. These combined heat and power generating plants preferably have a capacity of less than 100 kW, with particular preference less than 75 kW and with special preference less than 50 kW. These plants may be used multiply in an interconnected group, so that there is a common control system, which may be realized centrally or decentrally. The total capacity of the interconnected group is not subject to any limitation here, so that total capacities of at least 1 MW, preferably at least 5 MW, with particular preference at least 50 MW and with most particular preference at least 100 MW can be realized, this capacity representing the rated capacity under full load.

Furthermore, the present invention concerns a facility for carrying out the present method that is characterized in that the facility comprises at least one consuming entity with at least one device to be heated, at least one apparatus for the oxidation of a hydrocarbon-containing gas and at least one apparatus for providing heat by using electrical power, the device to be heated being designed such that it can be heated both by the apparatus for the oxidation of a hydrocarbon-containing gas and by the apparatus for providing heat by using electrical power, and the facility comprises at least one control device which is connected via data lines to the apparatuses for generating heat, a means for measuring the load of the electricity network and a means for determining the demand for thermal energy, the means for determining the demand for thermal energy being in connection with the device to be heated.

The term consuming entity should be understood within the scope of the present invention in a broad sense, and can be for example a single-family dwelling, a multi-family dwelling, a small business or an industrial plant. A consuming entity comprises at least one device to be heated. This device depends on the type of consuming entity, the device to be heated being connected to the two apparatuses for generating heat, to be specific at least one apparatus for the oxidation of a hydrocarbon-containing gas and at least one apparatus for providing heat by using electrical energy. The type of connection may be designed very differently depending on the consuming entity, so that these apparatuses for generating heat may be arranged directly in a device a device to be heated or at least one of the apparatuses for generating heat may be connected to a device a device to be heated, for example by at least one steam line or some other heat-carrying line.

The devices to be heated include, inter alia, heating boilers that can be heated with a gas burner and/or a heating coil. In an industrial plant, for example, a steam generator operated with gas may provide steam for various parts of the plant, for example stills, reactors or pipelines, where these parts of the plant can respectively be heated by heating coils, by microwaves or induction.

The method of the present invention may be carried out with preference with a facility which, in addition to an apparatus for the oxidation of a hydrocarbon-containing gas and an apparatus for providing heat by using electrical power, comprises a control device.

The control device is preferably connected, inter alia, to the apparatus for the oxidation of a hydrocarbon-containing gas and the apparatus for providing heat by using electrical power, so that data can be exchanged. This data exchange may by customary means and methods that have been previously mentioned. Furthermore, the control device may be connected to a sensor, for example a temperature sensor, which determines the heat requirement of a consuming entity.

Furthermore, it may be provided that the control device is connected to a means for determining the load of the electricity transmission network. Here, the means for determining the load of the electricity transmission network may determine the load at one or more points of the electricity transmission network. Preferably, the node points of the electricity transmission network previously defined in particular by substations or switching systems may have measuring devices that determine the load of the respective electricity lines. Generally, the corresponding data may be determined on the aforementioned switching systems and/or transformers that are operated for example in substations, so that means for determining the load of the electricity transmission network may for example be designed as a power measuring device or as a temperature sensor, which determines the load of the electricity network or of the corresponding power line according to the methods previously defined. Preferably, the control device is connected indirectly or directly to these facilities or may obtain the corresponding data actively or passively. Thus, this data may be actively sent from the switching systems and/or transformers directly to the control device. Furthermore, the control device may obtain this data from the switching systems and/or transformers directly or via databases by making a corresponding enquiry. The previously defined interfaces and data transmission devices can be used for this purpose.

The control device may be connected here to individual components of the facility by one line each. Furthermore, these components may however also be connected to the control device via a single line. In this case, one or more distributors, which can collect appropriate data of the individual components and pass it on to the control device, may be provided for example.

Further properties of the control device, in particular the design as a computer system and the embodiment where the control device is equipped with communication devices, have already been described, so reference is made thereto.

Preferably, the facility may comprise a gas reservoir. In this embodiment, it may be provided with preference that the control device is connected via a data line to a valve, which is installed in the gas line that supplies the apparatus for the oxidation of a hydrocarbon-containing gas with gas and can divert gas into the gas reservoir when electricity is used for generating heat.

According to a further embodiment, the facility of the present invention may comprise multiple consuming entities, for example single-family or multi-family dwellings or small businesses. The heating system of the consuming entities respectively comprises an apparatus for the oxidation of a hydrocarbon-containing gas and an apparatus for providing heat by using electrical power as well as a device to be heated. In this embodiment, these components are preferably controlled by a common control system via data lines. In particular, a heat requirement is transmitted to the control device, which may be determined with a sensor, for example a temperature sensor. For the provision of this thermal energy, the control device may transmit corresponding control signals to the apparatus for the oxidation of a hydrocarbon-containing gas, to the apparatus for providing heat by using electrical power or to both apparatuses.

Furthermore, it may be provided that the facility has a means for determining the demand for thermal energy, this means preferably being connected to the aforementioned control device. Furthermore, the means for determining the demand for thermal energy may be in connection with the device to be heated. This connection to the device to be heated is not subject to any specific limitation, but arises from the method of determination with which the means determines the heat requirement. These means include in particular sensors, for example temperature sensors, and heat-requirement measuring devices or other control units for setting a predetermined temperature or a predetermined temperature range.

Preferably, this means for determining the demand for thermal energy or the control system may be provided with a unit which calculates from the data that is provided by this means for determining the demand for thermal energy as well as further data, for example historical data on the historical consumption, data on the heat capacity and the final temperature to be achieved or production data of chemical plants, an amount of thermal energy to be provided, which is alternatively provided by way of the oxidation of a hydrocarbon-containing gas or the use of electrical energy.

Alternatively, it is sufficient that the means for determining the demand for thermal energy transmits a heat requirement to the control system and, when a predetermined temperature is achieved, likewise reports this event, it being possible in this way for feedback control to be achieved. The thermal energy respectively required for the heating-up operations may be provided in each case of need specifically by the oxidation of a hydrocarbon-containing gas and/or by electricity.

A timely response to a high load of the electricty network or an offer to supply electricity and the substitutability give rise to advantages, in particular that of a small size of a possible heat reservoir. Thus, a preferred facility with which the method is carried out does not require a heat reservoir that can store more than the heat requirement for a week or more. Preferably, the heat storage capacity is at most 200% of the heat requirement for one day, with particular preference at most 100% and with particular preference at most 50%.

Further embodiments of the facility have previously been described with respect to the method, so reference is made thereto.

Exemplary embodiments of the invention are explained below on the basis of three schematically represented figures, without thereby restricting the invention. In the figures:

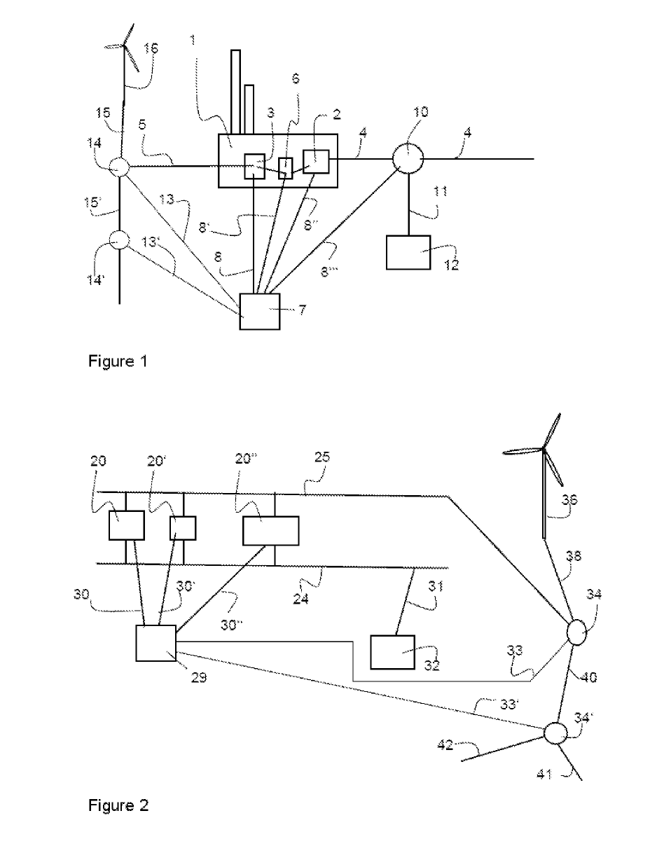

FIG. 1 shows a schematic representation of a first embodiment of a facility according to the invention for carrying out the present method;

FIG. 2 shows a schematic representation of a second embodiment of a facility according to the invention for carrying out the present method and

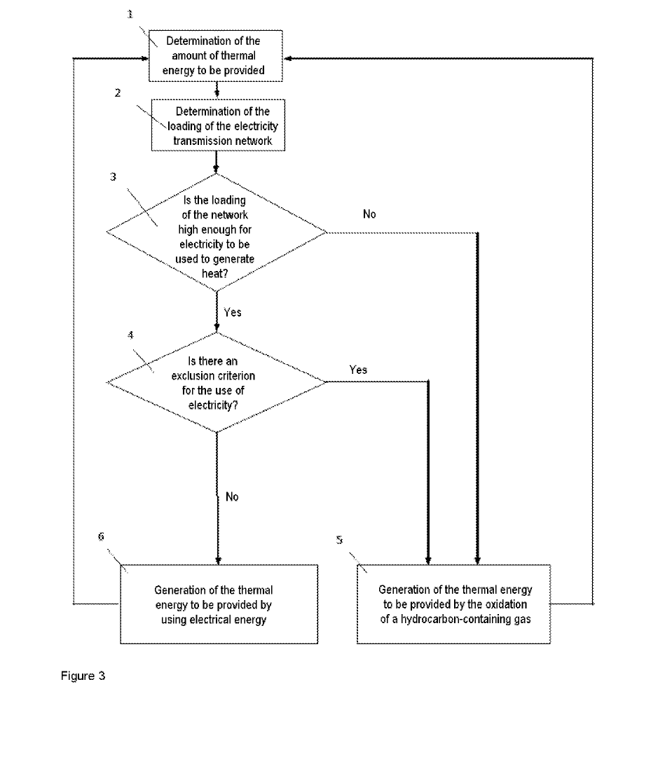

FIG. 3 shows a flow diagram for an embodiment of a method according to the invention.

FIG. 1 shows a schematic setup of a preferred embodiment of a facility for carrying out the method according to the invention. This facility comprises a consuming entity 1, where this may for example be an industrial plant, the heat requirement of which can be covered alternatively by way of an apparatus for the oxidation of a hydrocarbon-containing gas 2 and/or an apparatus for providing heat by using electrical power 3. The apparatus for the oxidation of a hydrocarbon-containing gas 2 is supplied with fuel by a gas line 4, whereas the apparatus for providing heat by using electrical power 3 is connected to an electricity line 5. The apparatuses for generating thermal energy heat up a device to be heated 6, the present representation being very schematic. In a household, for example, a heating boiler may be a device to be heated 6, which can be heated with a gas burner and/or a heating coil. In an industrial plant, a steam generator operated with gas may for example provide steam for various parts of the plant, for example stills, reactors or pipelines, it being possible for these parts of the plants respectively to be heated with heating coils, by microwaves or induction. The device to be heated 6 is accordingly connected to the two apparatuses for generating heat 2, 3, it being possible for this connection to be designed in very different ways, so that these apparatuses for generating heat 2, 3 may be arranged directly in a device or these apparatuses for generating heat 2, 3 may for example be connected to the device to be heated 6 by steam lines or other heat-carrying lines, as explained above by way of example. The present facility also comprises a control device 7, which is connected via data lines 8, 8′ and 8″ to the apparatuses for generating heat 2, 3 and a means for determining the demand for thermal energy, which is not represented for reasons of overall clarity. The means for determining the demand for thermal energy is in turn connected to the device to be heated 6. This connection is dependent on the method of determining the heat requirement. The means for determining the requirement for thermal energy may be designed, inter alia, as a sensor, for example as a temperature sensor, which measures the temperature of the device to be heated and transmits this measurement result to the control device 7.

The embodiment presented here shows one line respectively to the individual components, but these components may also be connected to the control device via a single line. In this case, one or more distributors, which can collect appropriate data of the individual components and pass it on to the control device 7, may be provided for example. With a further data line, the control device 7 is connected to a valve 10, which is installed in the gas line 4 and can divert gas via the line 11 into a gas reservoir 12 when electricity is used for generating heat.

Usually, gas is for example bought under long-term contracts and used for providing heat, the heating method being changed over, such that gas can be provided, when there is a high load of the electricity transmission network. This gas is in the present case transferred to the reservoir 12 and can be used for various purposes, which have been explained above. For example, gas may be offered as control energy on the gas market. Furthermore, the gas may be sold, in particular when the price is high.

Furthermore, the control device 7 is connected via data lines 13 and 13′ to node points of the electricity transmission network 14 and 14′, which for example connect different voltage levels of the network or switch different part-networks. These node points may for example represent substations with transformers or switching systems. The individual node points 14, 14′ may be connected to one another via power lines 15, 15′. Furthermore, the electricity network may comprise plants for electricity generation 16, which provide electricity. Contained in the node points are means for measuring the load of the electricity network, for example temperature sensors or current measuring devices, the data obtained by these means being transmitted via the data lines 13, 13′ to the control device 7.

If a high power output is fed into the network for example via the plants for electricity generation 16, so that the power line 15′ is subjected to very high load, electricity for generating heat can be passed to the consuming entity 1 via power line 5. This has the effect of relieving the line 15′.

In FIG. 2, a further embodiment of a facility for carrying out the present method is schematically represented, the apparatuses for generating heat that have previously been explained in more detail not being described for reasons of overall clarity. FIG. 2 shows various consuming entities 20, 20′ and 20″, which are respectively connected by a gas line 24 and an electricity line 25. The consuming entities 20, 20′ and 20″ may for example be single-family or multi-family dwellings or small businesses. The heating system of the consuming entities 20, 20′ and 20″ has of course at least one apparatus described in more detail in FIG. 1 for the oxidation of a hydrocarbon-containing gas and at least one apparatus for providing heat by using electrical power as well as a device to be heated. These components are controlled by a control system 29 via data lines 30, 30′ and 30″, which the control device 29 to the respective consuming entities 20, 20′ and 20″. In particular, a heat requirement is transmitted to the control device 29, which is determined by way of a corresponding means and can be ascertained by way of a sensor, for example a temperature sensor. For the provision of this thermal energy, the control device 29 may transmit corresponding control signals to the apparatus for the oxidation of a hydrocarbon-containing gas, to the apparatus for providing heat by using electrical power or to both apparatuses. The amount of gas made available by the use of electricity can be withdrawn from the gas network via the gas conduit 31 and stored in the gas reservoir 32, and be provided.

The control device 7 is connected via the data lines 33, 33′ to node points 34, 34′ of the electricity network, which have been described more specifically with reference to FIG. 1 and contain means for measuring the load of the electricity network, for example temperature sensors or current measuring devices. The data obtained by these means is transmitted via the data lines 33, 33′ to the control device 7.

The node points 34, 34′ are connected via power line 40. Here, node point 34 is connected to a plant for electricity generation 36, for example a wind power plant, via power line 38. The node points have further power lines 41, 42, which lead to not represented node points, consumers or power plants.

When there is severe load of the power line 40, electrical energy may be used via line 25 for generating heat. This allows the load of the power line 40 to be limited.

In FIG. 3, a flow diagram for a preferred method of the present invention is presented. In step 1, the amount of thermal energy to be provided is determined. The method of determination to be used for this can be chosen to be very simple, for example by measuring the temperature of a component or by a liquid. If the actual temperature is less than the desired temperature, thermal energy is required, and is provided in the following method steps. In advanced embodiments, a means for determining or predicting the required amount of energy may be used for this, for example a computer which calculates the required amount of electrical energy from the difference between the actual temperature and the desired temperature and transmits to the control device the amount of electrical energy or chemical energy in the form of gas that is respectively required to achieve the intended desired temperature.

In step 2, the load of the electricity transmission network is determined. This determination may take place by way of appropriate means, for example temperature sensors or current-measuring devices at node points of the electricity network, and be transmitted to a control system.

If the network load is low, the energy to be provided is generated by oxidation of a hydrocarbon-containing gas, as stated in step 5. When there is a high load of the electricity transmission network, it may be enquired in an optional step 4 whether there is an exclusion criterion for the use of electricity. This may for example take the form of a defect of the apparatus for providing heat by using electrical power. If there is an exclusion criterion, the thermal energy to be provided is generated by the use of gas, as provided by step 5 according to the present flow diagram.

If there is no exclusion criterion, according to the present flow diagram the heat to be provided is created by the use of electrical energy.

The features of the invention that are disclosed in the description above and the claims, figures and exemplary embodiments may be essential for realizing the invention in its various embodiments both individually and in any desired combination.

1-27. (canceled)

28. A method for limiting the load of electricity transmission networks, the method comprising the generation of heat by operating an apparatus for the oxidation of a hydrocarbon-containing gas, wherein alternatively a required provision of heat from the oxidation of the hydrocarbon-containing gas is substituted by the provision of heat from electrical energy with an apparatus for providing heat by using electrical power and the hydrocarbon-containing gas that is not oxidized is provided.

29. The method of claim 28, wherein the electricity transmission network is operated with a voltage of at least 10 kV.

30. The method of claim 28, wherein the hydrocarbon-containing gas provided is stored.

31. The method of claim 28, wherein the hydrocarbon-containing gas provided is fed into a natural gas network that is connected to a gas power plant.

32. The method of claim 28, wherein the electrical energy that is alternatively used for providing heat originates at least partially from renewable energy sources.

33. The method of claim 28, wherein the electricity transmission network of which the load is to be limited connects at least two subnets or is made up of at least two subnets.

34. The method of claim 28, wherein the electricity transmission network of which the load is to be limited is connected to subnets or is made up of subnets, the electrical energy that is alternatively used for providing heat being consumed and being provided by plants, preferably plants for generating electricity from renewable energy sources, within a subnet.

35. The method of claim 34, wherein the subnet comprises multiple component networks or is connected to them.

36. The method of claim 28, wherein the load of the electricity transmission network before the electrical energy is used for providing thermal energy is at least 70%, based on the maximum continuous load capability of the electricity network.

37. The method of claim 28, wherein the hydrocarbon-containing gas provided is fed into a natural gas network that is connected to a gas power plant, and is used in the gas power plant for generating electricity, and the electricity transmission network of which the load is to be limited is connected to subnets or is made up of subnets, the electrical energy that is alternatively used for providing heat not generating heat in the subnet into which the gas power plant feeds electricity.

38. The method of claim 28, wherein an amount of thermal energy to be provided within a specific time period is alternatively provided by burning gas and/or by using electrical energy.

39. The method of claim 38, wherein the specific time period within which an amount of thermal energy is to be provided is at most 24 hours.

40. The method of claim 38, wherein the decision with regard to the type of provision of the thermal energy is taken at most 12 hours before the time period within which the thermal energy is to be provided.

41. The method of claim 28, wherein the apparatus for the oxidation of a hydrocarbon-containing gas comprises a combined heat and power generating plant.

42. The method of claim 28, wherein the ratio of the heating capacity achievable by gas to the heating capacity that is provided by electrical energy lies in the range from 2:1 to 1:2.

43. The method of claim 28, wherein the facility with which the method is carried out does not comprise a heat reservoir that can store more than the heat requirement for a week.

44. The method of claim 28, wherein the electrical energy is transformed into heat by resistance heating.

45. The method of claim 28, wherein the electrical energy is transformed into heat by microwaves.

46. The method of claim 28, wherein electrical energy is transformed into heat by induction heating.

47. The method of claim 28, wherein the thermal energy serves for generating steam.

48. The method of claim 28, wherein the method is used in conjunction with the generation of chemical products.

49. The method of claim 28, wherein the method is used in a unit-type cogenerating plant.

50. The method of claim 28, comprising the following steps
a) determining the load of the electricity transmission network,
b) use of the electrical energy for generating heat if the load of the electricity transmission network exceeds a predetermined value,
c) use of gas for generating heat if the load of the electricity transmission network is below the aforementioned predetermined value.

51. The method of claim 28, wherein the heat generated from electrical energy increases the temperature of a liquid by at least 10° C.

52. A facility for carrying out the method of claim 28, comprising at least one consuming entity with at least one device to be heated, at least one apparatus for the oxidation of a hydrocarbon-containing gas and at least one apparatus for providing heat by using electrical power, the device to be heated being designed such that it can be heated both by the apparatus for the oxidation of a hydrocarbon-containing gas and by the apparatus for providing heat by using electrical power, and further comprising at least one control device which is connected via data lines to the apparatuses for generating heat, a means for measuring the load of the electricity network and a means for determining the demand for thermal energy, the means for determining the demand for thermal energy being in connection with the device to be heated.

53. The facility of claim 52, wherein the device to be heated is a heating boiler.

54. The facility of claim 52, comprising at least one gas reservoir.
